(19) United States
(12) Patent Application Publication
(10) Pub. No.: US 2015/0015164 A1
(43) Pub. Date: Jan. 15, 2015

(54) LIGHT-EMITTING DIODE LIGHTING DEVICE HAVING MULTIPLE DRIVING STAGES

(71) Applicant: IML International, Grand Cayman (KY)

(72) Inventors: Horng-Bin Hsu, Taipei City (TW); Yi-Mei Li, New Taipei City (TW)

(73) Assignee: IML International, Grand Cayman (KY)

(21) Appl. No.: 14/267,916

(22) Filed: May 2, 2014

Related U.S. Application Data
(60) Provisional application No. 61/844,438, filed on Jul. 10, 2013.

(51) Int. Cl. H05B 33/08

(52) U.S. Cl. CPC H05B 33/0809
USPC 315/294

(57) ABSTRACT

An LED lighting device includes multiple driving stages. A first driving stage includes a first luminescent device driven by a first current, a second luminescent device driven by a second current, a path-controller for conducting a third current, a first current controller for regulating the first current, and a second current controller for regulating the second current. The second driving stage includes a third current controller coupled in series to the first driving stage and configured to conduct and regulate a fourth current. When the path-controller is turned off, the third current is zero, and the fourth current is equal to the sum of the first current and the second current. When the path-controller is turned on, the first current, the second current, the third current and the fourth current is equal.

### CROSS REFERENCE TO RELATED APPLICATIONS

This application claims the benefit of U.S. provisional application No. 61/844,438 filed on Jul. 10, 2013.

### BACKGROUND OF THE INVENTION

1. Field of the Invention

The present invention is related to an LED lighting device having multiple driving stages, and more particularly, to an LED lighting device having multiple driving stages for providing wide effective operational voltage range without causing image flicker and uniformity issue.

2. Description of the Prior Art

Compared to traditional incandescent bulbs, light-emitting diodes (LEDs) are advantageous in low power consumption, long lifetime, small size, no warm-up time, fast reaction speed, and the ability to be manufactured as small or array devices. In addition to outdoor displays, traffic signs, and liquid crystal display (LCD) for various electronic devices such as mobile phones, notebook computers or personal digital assistants (PDAs), LEDs are also widely used as indoor/outdoor lighting devices in place of fluorescent of incandescent lamps.

An LED lighting device is normally driven by a rectified alternative-current (AC) voltage and adopts a plurality of LEDs coupled in series in order to provide required luminance. In a conventional method for driving an LED lighting device, the LEDs may be light up in steps in order to increase the effective operational voltage range. The LEDs which are turned on more frequently are aged faster than those which are turned on less frequently, thereby causing uniformity issue. Image flicker may also occur at low rectified AC voltage when not all LEDs are light up. Therefore, there is a need for an LED lighting device capable of improving the effective operational voltage range without causing image flicker and uniformity issue.

### SUMMARY OF THE INVENTION

The present invention provides an LED lighting device having a first driving stage and a second driving stage. The first driving stage includes a first luminescent device for providing light according to a first current; a second luminescent device for providing light according to a second current; a first current controller coupled in series to the first luminescent device and configured to regulate the first current so that the first current does not exceed a first value; a second current controller coupled in series to the second luminescent device and configured to regulate the second current so that the second current does not exceed a second value; a first path-controller configured to conduct a third current and comprising a first end coupled between the second luminescent device and the second current controller; and a second end coupled to the first current controller. The second driving stage includes a third current controller coupled in series to the first driving stage and configured to conduct a fourth current and regulate the fourth current so that the fourth current does not exceed a third value. When the first path-controller is turned off, the third current is zero, and the fourth current is equal to a sum of the first current and the second current. When the first path-controller is turned on, the first current, the second current, the third current and the fourth current is equal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an LED lighting device according to an embodiment of the present invention.

FIGS. 2˜6 are diagrams illustrating the operation of the multiple driving stages.

FIG. 7 is a diagram illustrating the overall operation of the LED lighting device according to the present invention.

FIG. 8 is a diagram of an LED lighting device according to another embodiment of the present invention.

### DETAILED DESCRIPTION

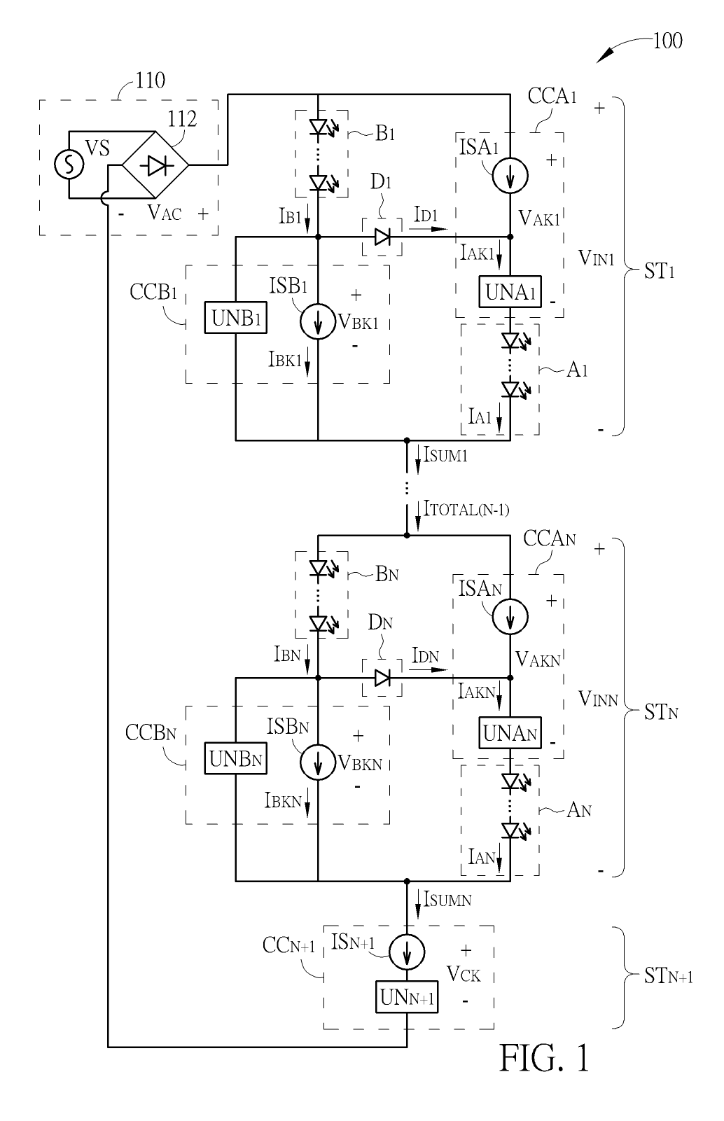

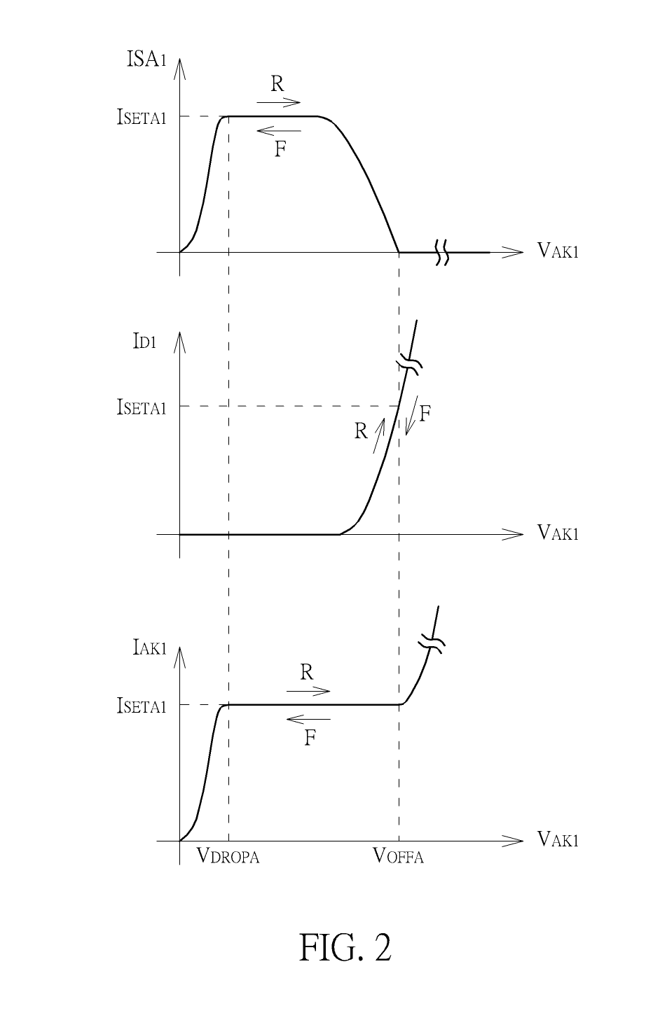

FIG. 1 is a diagram of an LED lighting device 100 according to an embodiment of the present invention. The LED lighting device 100 includes a power supply circuit 110 and (N+1) driving stages ST₁˜ST_{N+1} (N is a positive integer). The power supply circuit 110 is configured to receive an AC voltage VS having positive and negative periods and convert the output of the AC voltage VS in the negative period using a bridge rectifier 112, thereby providing a rectified AC voltage V_{AC}, whose value varies periodically with time, for driving the (N+1) driving stages. In another embodiment, the power supply circuit 110 may receive any AC voltage VS, perform voltage conversion using an AC-AC converter, and rectify the converted AC voltage VS using the bridge rectifier 112, thereby providing the rectified AC voltage V_{AC} whose value varies periodically with time. The configuration of the power supply circuit 110 does not limit the scope of the present invention.

Each of the 1^{st} to N^{th} driving stages ST₁˜ST_{N} includes a plurality of luminescent devices, a path controller, a first-type current controller and a second-type current controller. The (N+1)^{th} driving stage ST_{N+1} includes a third-type current controller. Each first-type current controller includes an adjustable current source and a current detection and control unit. Each second-type current controller includes an adjustable current source and a voltage detection and control unit. The third-type current controller includes an adjustable current source and a detection and control unit.

For illustrative purposes, the following symbols are used to represent each device in the LED lighting device 100 throughout the description and figures. A₁˜A_{N} and B₁˜B_{N} represent the luminescent devices in the corresponding driving stages ST₁˜ST_{N}, respectively. D₁˜D_{N} represent the path-controllers in the corresponding driving stages ST₁˜ST_{N}, respectively. CCA₁˜CCA_{N} represent the first-type current controllers in the corresponding driving stages ST₁˜ST_{N}, respectively. CCB₁˜CCB_{N} represent the second-type current controllers in the corresponding driving stages ST₁˜ST_{N}, respectively. CC_{N+1} represents the third-type current controller in the (N+1)^{th} driving stage ST_{N+1}. ISA₁˜ISA_{N} represent the adjustable current sources in the corresponding first-type current controllers CCA₁˜CCA_{N}, respectively. ISB₁˜ISB_{N} represent the adjustable current sources in the corresponding second-type current controllers CCB₁˜CCB_{N}, respectively. IS_{N+1} represents the adjustable current source in the third-type current controller CC_{N+1}. UNA₁˜UNA_{N} represent the current detection and control units in the corresponding first-type current controllers CCA₁˜CCA_{N}, respectively. UNB₁˜UNB_{N} represent the voltage detection and control units in the corresponding second-type current controllers CCB₁˜CCB_{N}, respectively. UN_{N+1} represents the detection and control unit in the (N+1)^{th} driving stage ST_{N+1}.

For illustrative purposes, the following symbols are used to represent related current/voltage in the LED lighting device 100 throughout the description and figures. V_{IN1}˜V_{INN} represent the voltages established across the 1^{st} to N^{th} driving stages ST₁˜ST_{N}, respectively. V_{AK1}˜V_{AKN} represent the voltages established across the corresponding first-type current controllers CCA₁˜CCA_{N}, respectively. V_{BK1}˜V_{BKN} represent the voltages established across the corresponding second-type current controllers CCB₁˜CCB_{N}, respectively. V_{CK} represents the voltage established across the third-type current controller CC_{N+1}. I_{AK1}˜I_{AKN} represent the current flowing through the corresponding first-type current controllers CCA₁˜CCA_{N}, respectively. I_{BK1}˜I_{BKN} represent the current flowing through the corresponding second-type current controllers CCB₁˜CCB_{N}, respectively. I_{A1}˜I_{AN} represent the current flowing through the corresponding luminescent devices A₁˜A_{N}, respectively. I_{B1}˜I_{BN} represent the current flowing through the corresponding luminescent devices B₁˜B_{N}, respectively. I_{D1}˜I_{DN} represent the current flowing through the corresponding path controllers D₁˜D_{N}, respectively. I_{SUM1}˜I_{SUMN} represent the current flowing through the corresponding driving stages ST₁˜ST_{N}, respectively. The overall current of the LED lighting device 100 may be represented by I_{SUMN}.

In the 1^{st} to N^{th} driving stages ST₁˜ST_{N}, the current detection and control units UNA₁˜UNA_{N}, respectively coupled in series to the corresponding luminescent devices A₁˜A_{N} and the corresponding adjustable current sources ISA₁˜ISA_{N}, are configured to regulate the values of the adjustable current sources ISA₁˜ISA_{N} according the current I_{AK1}˜I_{AKN}, respectively. The voltage detection and control units UNB₁˜UNB_{N}, respectively coupled in series to the corresponding luminescent devices B₁˜B_{N} and in parallel with the corresponding adjustable current sources ISB₁˜ISB_{N}, are configured to regulate the values of the adjustable current sources ISB₁˜ISB_{N} according the voltages V_{BK1}˜V_{BKN}, respectively.

In the (N+1)^{th} driving stage ST_{N+1}, the adjustable current source IS_{N+1} is coupled in series to the 1^{st} to N^{th} driving stages ST₁˜ST_{N}. In a first configuration, the detection and control unit UN_{N+1} of the third-type current controller CC_{N+1} may be coupled in series to the adjustable current source IS_{N+1} and is configured to regulate the value of the adjustable current source IS_{N+1} according the current I_{SUMN}. In a second configuration, the detection and control unit UN_{N+1} of the third-type current controller CC_{N+1} may be coupled in parallel with the adjustable current source IS_{N+1} and is configured to regulate the value of the adjustable current source IS_{N+1} according the voltage V_{CK}. FIG. 1 depicts the embodiment adopting the first configuration, but does not limit the scope of the present invention.

In the embodiment of the present invention, each of the luminescent devices A₁˜A_{N} and B₁˜B_{N} may adopt a single LED or multiple LEDs coupled in series, in parallel, or in array. FIG. 1 depicts the embodiment using multiple LEDs, but do not limit the scope of the present invention.

In the embodiment of the present invention, each of the path-controllers D₁˜D_{N} may adopt a diode or any device providing similar function. The embodiment of the path-controllers D₁˜D_{N} does not limit the scope of the present invention.

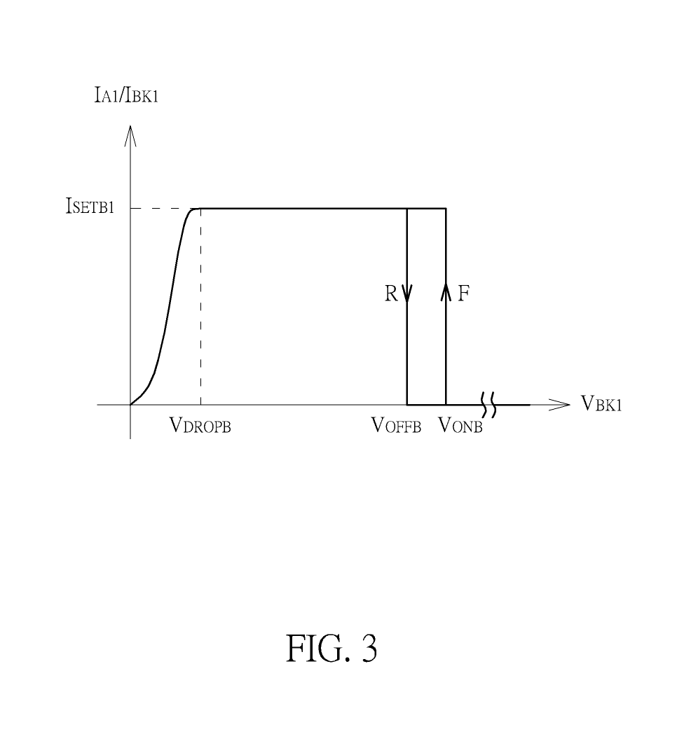

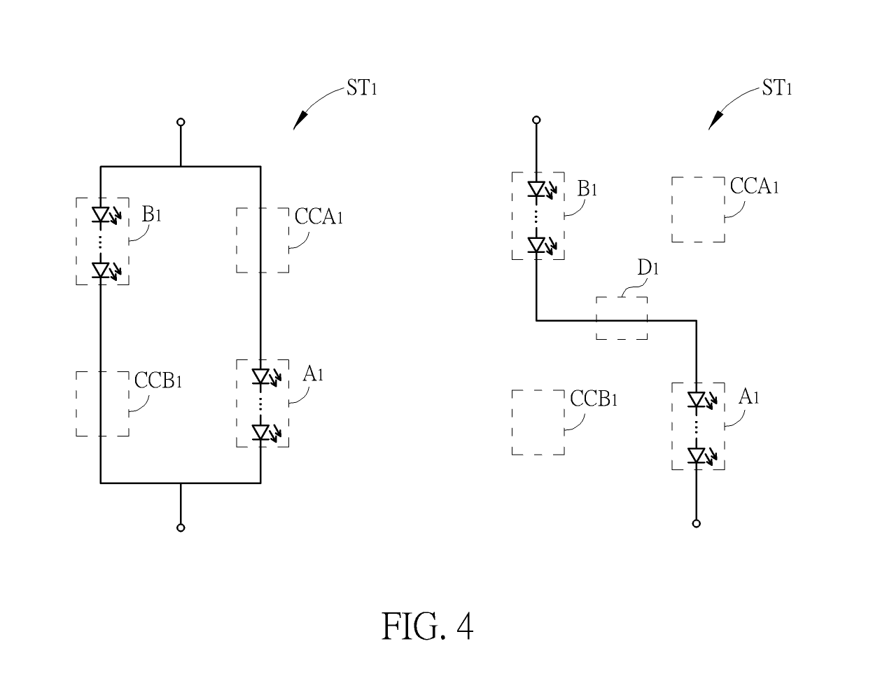

FIGS. 2-5 are diagrams illustrating the operation of the 1^{st} to N^{th} driving stages ST₁˜ST_{N}. The driving stage ST₁ is used for illustrative purpose, wherein FIG. 2 illustrates the current-voltage curve (I-V curve) of the first-type current controller CCA₁, FIG. 3 illustrates the I -V curve of the second-type current controller CCB₁, FIG. 4 illustrates the equivalent circuits of the 1^{st} driving stage ST₁ during different phases of operation, and FIG. 5 illustrates the I-V curve of the 1^{st} driving stage ST₁. FIG. 6 is a diagram illustrating the operation of the current controller CC_{N+1} in the (N+1)^{th} driving stages ST_{N+1}. V_{DROPA}, V_{DROPB} and V_{DROPC} represent the drop-out voltages for turning on the first-type current controller CCA₁, the second-type current controller CCB₁ and the third-type current controller CCB_{N+1}, respectively. V_{OFFA}, V_{OFFB} and V_{ONB} represent the threshold voltages based on which the first-type current controller CCA₁ or the second-type current controller CCB₁ switch operational modes. I_{SETA1}, I_{SETB1} and I_{SETC} are constant values which represent the current settings of the first-type current controller CCA₁, the second-type current controller and the third-type current controller CC_{N+1}, respectively. An arrow R indicates the rising period of the voltage V_{AK1}, V_{BK1} or V_{CK}. An arrow L indicates the falling period of the voltage V_{AK1}, V_{BK1} or V_{CK}.

In FIG. 2, during the rising and falling periods of the voltage V_{AK1} when 0<V_{AK1}<V_{DROPA}, the first-type current controller CCA₁ is not completely turned on and operates as a voltage-controlled device in a linear mode in which the current I_{AK1} changes with the voltage V_{AK1} in a specific manner.

During the rising and falling periods of the voltage V_{AK1} when V_{AK1}>V_{DROPA}, the current I_{AK1} reaches I_{SETA1}, and the first-type current controller CCA₁ switches to a constant-current mode and functions as a current limiter. The current detection and control unit UNA₁ is configured to clamp the current I_{AK1} at I_{SETA1}. For example, in response to an increase in the current I_{D1}, the current detection and control unit UNA₁ may decrease the value of the adjustable current source ISA₁ accordingly. Similarly, in response to a decrease in the current I_{D1}, the current detection and control unit UNA₁ may increase the value of the adjustable current source ISA₁ accordingly. Therefore, the current I_{AK1} (=I_{D1}+ISA₁) flowing through the 1^{st} driving stage ST₁ may be maintained at the constant value I_{SET1} instead of changing with the voltage V_{AK1}.

During the rising period of the voltage V_{AK1} before the current I_{D1} reaches I_{SETA1}, the current detection and control unit UNA₁ turns on the adjustable current source ISA₁ and the current controller CCA₁ functions as a current limiter in the constant-current mode in which the current I_{AK1} (=I_{SETA1}+I_{D1}) is clamped at a constant value of I_{SETA1}. When the current I_{D1} reaches I_{SETA1}, the current detection and control unit UNA₁ turns off the adjustable current source ISA₁ and the current controller CCA₁ switches to a cut-off mode in which the current I_{AK1} increases with the current I_{D1}.

During the falling period of the voltage V_{AK1} before the current I_{D1} drops I_{SETA1}, the current detection and control unit UNA₁ turns off the adjustable current source ISA₁ and the current controller CCA₁ operates in the cut-off mode in which the current I_{AK1} decreases with the current I_{D1}. When the current I_{D1} drops to I_{SETA1}, the current detection and control unit UNA₁ turns on the adjustable current source ISA₁ and the current controller CCA₁ functions as a current limiter in the constant-current mode in which the current I_{AK1} is clamped at a constant value of I_{SETA1}.

In FIG. 3, during the rising and falling cycles of the voltage V_{BK1} when 0<V_{BK1}<V_{DROPB}, the second-type current controller CCB₁ is not completely turned on and operates as a voltage-controlled device in the linear mode in which the current I_{BK1} changes with the voltage V_{BK1} in a specific manner.

During the rising period of the voltage V_{BK1} when V_{BK1}>V_{DROPB}, the current I_{BK1} reaches I_{SETB1}, and the current controller CCB₁ switches to the constant-current mode and functions as a current limiter. The voltage detection and control unit UNB₁ is configured to clamp the current I_{BK1} at I_{SETB1}.

During the rising period of the voltage V_{BK1} when V_{BK1}>V_{OFFB}, the voltage detection and control unit UNB₁ is configured to turn off the adjustable current source ISB₁ and the second-type current controller CCB₁ switches to the cut-off mode. In other words, the second-type current controller CCB₁ functions as an open-circuited device. During the falling cycle of the voltage V_{BK1} when V_{BK1}<V_{ONB}, the voltage detection and control unit UNB₁ is configured to turn on the adjustable current source ISB₁ and the current controller CCB₁ switches to the constant-current mode and functions as a current limiter, thereby clamping the current I_{BK1} at I_{SETB1}. The threshold voltage V_{ONB} is larger than or equal to the threshold voltage V_{OFFB}. In an embodiment, a non-zero hysteresis band (V_{ONB}-V_{OFFB}) may be provided in order to prevent the second-type current controller CCB₁ from frequently switching operational modes due to fluctuations in the voltage V_{BK1}.

In FIG. 4, when the 1^{st} driving stage ST₁ operates in a first phase with V1<V_{IN1}<V2, the luminance device A₁ is coupled in parallel with the luminance device B₁, as depicted on the left of FIG. 4. When the 1^{st} driving stage ST₁ operates in a second phase with V_{IN1}>V3, the luminance device A₁ is coupled in series to the luminance device B₁, as depicted on the right of FIG. 4.

In FIG. 5, during the rising period when the voltage V_{IN1} is low, the luminance device A₁, the luminance device B₁ and the path-controller D₁ remain off. During the rising period as the voltage V_{IN1} reaches a turn-on voltage V_{A1} which is the sum of the cut-in voltage for turning on the luminance device A₁ and the cut-in voltage for turning on the first-type current controller CCA₁, the first-type current controller CCA₁ and the luminance device A₁ are turned on, allowing the current I_{A1} to gradually increase with the voltage V_{IN1} until reaching I_{SETA1}; during the rising period as the voltage V_{IN1} reaches a turn-on voltage V_{B1} which is the sum of the cut-in voltage for turning on the luminance device B₁ and the cut-in voltage for turning on the second-type current controller CCB₁, the second-type current controller CCB₁ and the luminance device B₁ are turned on, allowing the current I_{B1} to gradually increase with the voltage V_{IN1} until reaching I_{SETB1}. With the path controller D1 still off, the current I_{SUM1} is equal to the sum of the current I_{A1} and the current I_{B1}, wherein the current I_{A1} is regulated by the current controllers CCA₁ and the current I_{B1} is regulated by the current controllers CCB₁. The value of the turn-on voltage V_{A1} may be equal to or different from that of the turn-on voltage V_{B1}. In other words, the current I_{SUM1} starts to increase at a voltage V1 which is equal to the smaller one among the turn-on voltage V_{A1} and the turn-on voltage V_{B1}.

During the rising period when the voltage V_{IN1} reaches V2 so that V_{BK1}=V_{OFFB}, the second-type current controller CCB₁ switches to the cut-off mode in which the current I_{A1} is directed towards the path-controller D₁, thereby turning on the path-controller D1. The current I_{SUM1} is equal to the current I_{B1}, wherein both the current I_{A1} and the current I_{B1} are regulated by the first-type current controller CCA₁. As the current I_{A1} flows through the path-controller D₁, the current I_{D1} gradually increases with the voltage V_{IN1}. In response, the first-type current controller CCA₁ decreases the value of the adjustable current source ISA₁ accordingly, so that the overall current I_{AK1} is still maintained at the constant value I_{SETA1}. When the value of the current source ISA₁ drops to zero at V_{IN1}=V3, the first-type current controller CCA₁ switches to the cut-off mode. The current I_{SUM1} is now regulated by the subsequent driving stage.

In FIG. 6, during the rising and falling periods of the voltage V_{CK} when 0<V_{CK}<V_{DROPC}, the third-type current controller CC_{N+1} is not completely turned on and operates as a voltage-controlled device in the linear mode in which the current I_{CK} changes with the voltage V_{CK} in a specific manner. During the rising and falling cycles of the voltage V_{CK} when V_{CK}>V_{DROPC} the current I_{CK} reaches I_{SETC}, and the third-type current controller CC_{N+1} switches to the constant-current mode and functions as a current limiter.

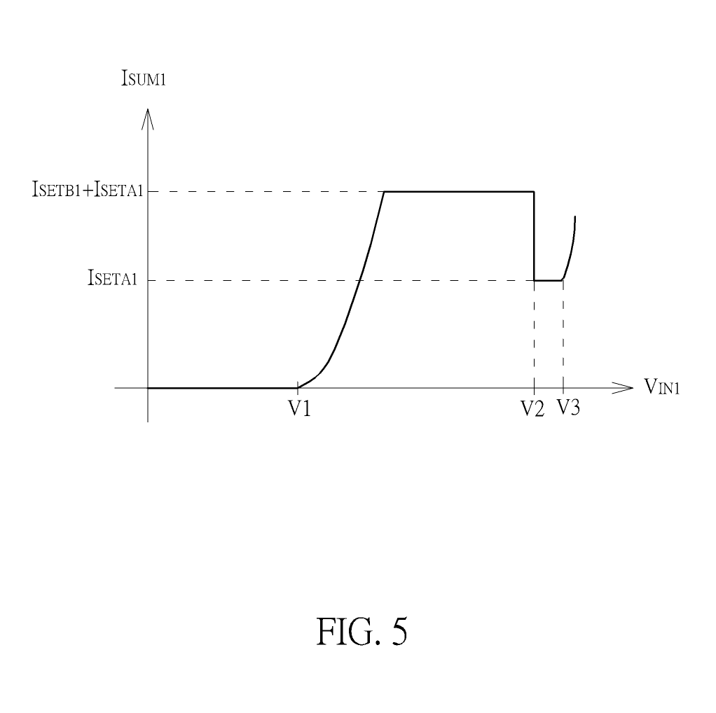

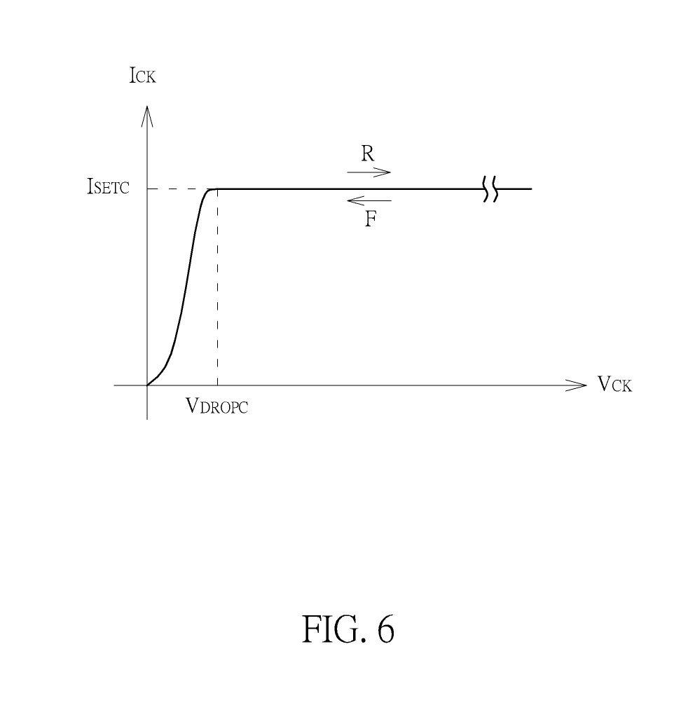

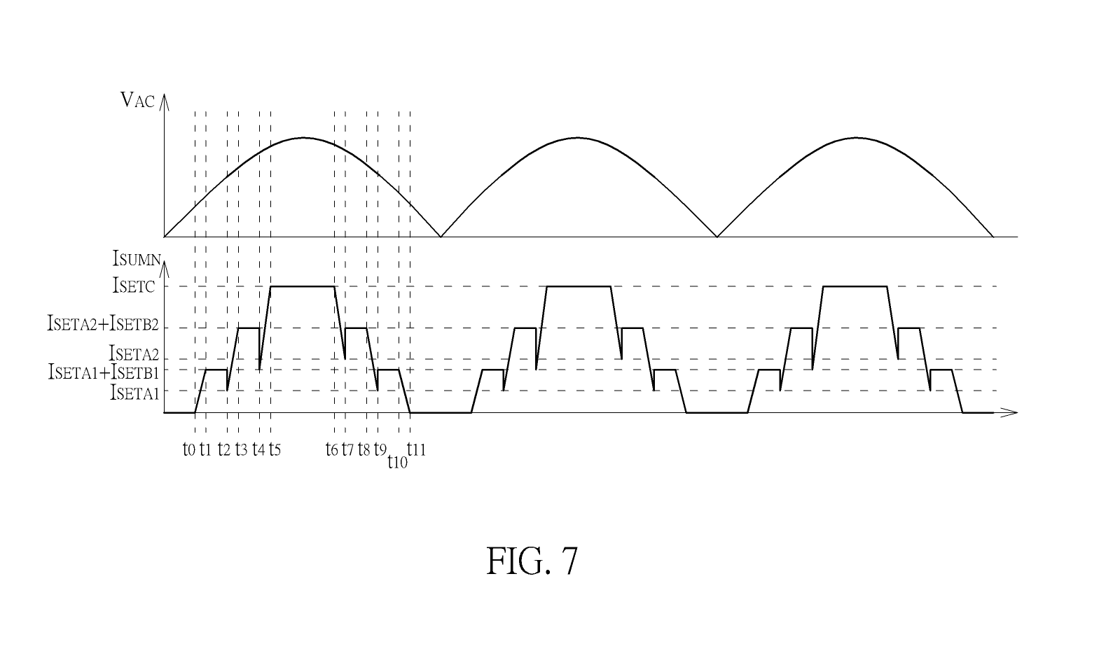

FIG. 7 is a diagram illustrating the overall operation of the LED lighting device 100 according to the present invention. The embodiment when N=2 is used for illustrative purpose. Since the voltages V_{IN1}˜V_{IN2}, V_{AK1}˜V_{AK2}, V_{BK1}˜V_{BK2} and V_{CK} are associated with the rectified AC voltage V_{AC} whose value varies periodically with time, a cycle of t₀-t₁₁ is used for illustration, wherein the period between t₀-t₅ belongs to the rising period of the rectified AC voltage V_{AC} and the period between t₆-t₁₁ belongs to the falling period of the rectified AC voltage V_{AC}.

Before t₀, the rectified AC voltage V_{AC} is low and the voltages V_{IN1}˜V_{IN2} are insufficient to turn on the luminescent devices A₁˜A₂ and B₁˜B₂ or the current controllers CCA₁˜CCA₂, CCB₁˜CCB₂ and CC₃. Therefore, all the 3 driving stages ST1˜ST3 operate in the cut-off mode, and the overall current I_{SUMN} of the LED lighting device 100 is zero.

Between t₀˜t₁, all 3 driving stages ST₁˜ST₃ operate in the linear mode in which the overall current I_{SUMN} of the LED lighting device 100 increases with the rectified AC voltage V_{AC} in a specific manner. Between t₁˜t₂, the first driving stage ST₁ switches to the constant-current mode and the current I_{SUM1} is maintained at a constant value (I_{SUM1}=I_{SETA1}+I_{SETB1}) regardless of the level of the rectified AC voltage V_{AC}. Therefore, the overall current I_{SUMN} of the LED lighting device 100 is regulated by the current controllers CCA₁ and CCB₁ between t₀˜t₂.

Between t₂˜t₃, the first driving stage ST₁ switches to the cut-off mode, while the second and third driving stages ST₂˜ST₃ remain operating in the linear mode in which the overall current I_{SUMN} of the LED lighting device 100 increases with the rectified AC voltage V_{AC} in a specific manner. Between t₃˜t₄, the second driving stage ST₂ switches to the constant-current mode and the current I_{SUM2} is maintained at a constant value (I_{SUM2}=I_{SETA2}+I_{SETB2}) regardless of the level of the rectified AC voltage V_{AC}. Therefore, the overall current I_{SUMN} of the LED lighting device 100 is regulated by the current controllers CCA₂ and CCB₂ between t₂˜t₄.

Between t₄˜t₅, the second driving stage ST₂ switches to the cut-off mode, while the third driving stage ST₃ remain operating in the linear mode in which the overall current I_{SUMN} of the LED lighting device 100 increases with the rectified AC voltage V_{AC} in a specific manner. Between t₅˜t₆, the third driving stage ST₃ switches to the constant-current mode and the current I_{SUMN} is maintained at a constant value (I_{SUMN}=I_{SETC}) regardless of the level of the rectified AC voltage V_{AC}. Therefore, the overall current I_{SUMN} of the LED lighting device 100 is regulated by the current controller CC₃.

The intervals t₀˜t₁, t₁˜t₂, t₂˜t₃, t₃˜t₄ and t₄˜t₅ during the rising period correspond to the intervals t₁₀˜t₁₁, t₉˜t₁₀, t₈˜t₉, t₇·t₈ and t₆˜t₇ during the falling period, Therefore, the operation of the LED lighting device 100 during t₆-t₁₁ is similar to that during t₀˜t₅, as detailed in previous paragraphs.

In an embodiment of the present invention, the current settings of the LED lighting device 100 may have the following relationship: (I_{SETA1}+I_{SETB1})<(I_{SETA2}+I_{SETB2})<I_{SETC}.

The following table summarizes the operational modes and phases of the 1^{st} to 3^{rd} driving stages ST₁˜ST₃, wherein mode 1 represents the linear mode, mode 2 represents the constant-current mode, and mode 3 represents the cut-off mode. Phase 1 and phase 2 respectively represent the first phase and the second phase in the operation of the equivalent circuits of the 1^{st} driving stage ST₁ depicted in FIG. 4.

| | t0~t1 | t1~t2 | t2~t3 | t3~t4 | t4~t5 | |
|---|---|---|---|---|---|---|
| | t10~t11 | t9~t10 | t8~t9 | t7~t8 | t6~t7 | t5~t6 |
| 1^{st} driving | mode 1 | mode 2 | mode 3 | mode 3 | mode 3 | mode 3 |
| stage | phase 1 | | phase 2 | | | |
| 2^{nd} driving | mode 1 | mode 1 | mode 1 | mode 2 | mode 3 | mode 3 |
| stage | phase 1 | | | | phase 2 | |
| 3^{rd} driving | mode 1 | mode 1 | mode 1 | mode 1 | mode 1 | mode 2 |
| stage | | | | | | |

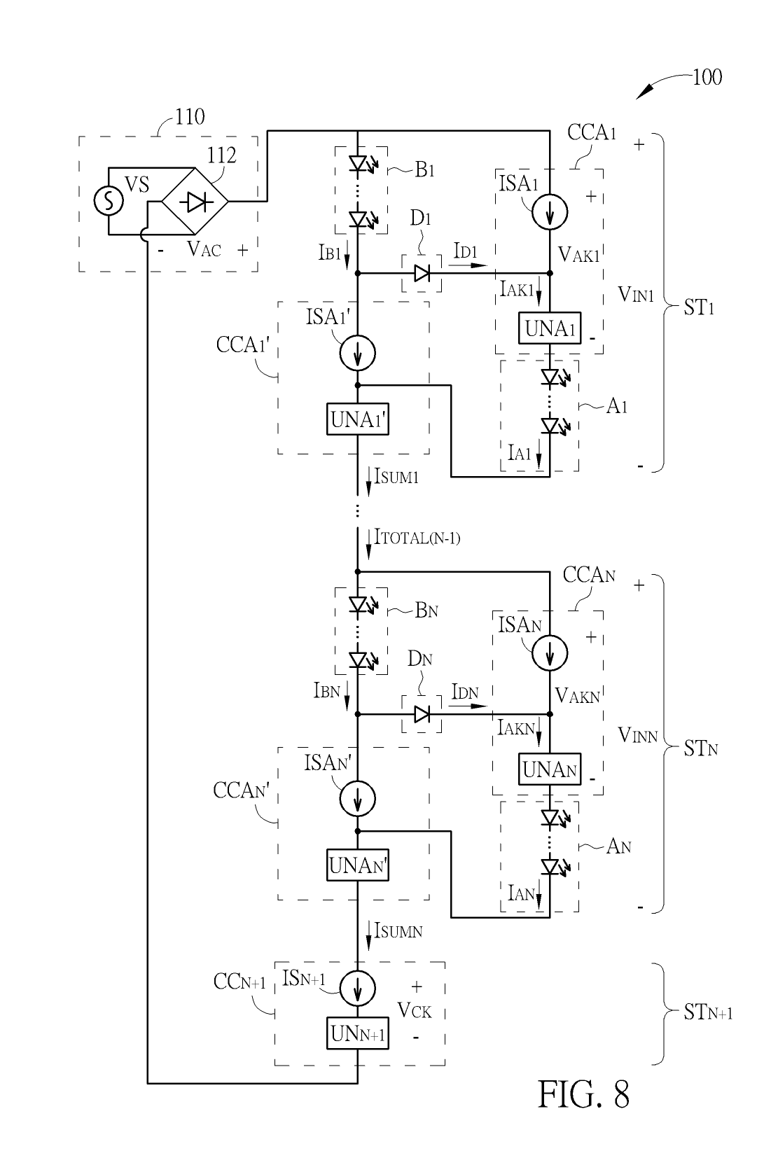

FIG. 8 is a diagram of an LED lighting device 200 according to another embodiment of the present invention. Similar to the LED lighting device 100 depicted in FIG. 1, the LED lighting device 200 also includes a power supply circuit 110 and (N+1) driving stages ST₁˜ST_{N+1} (N is a positive integer). However, the LED lighting device 200 differs from the LED lighting device 100 in that each of the 1^{st} to N^{th} driving stages ST₁˜ST_{N} includes a plurality of luminescent devices, a path controller, and two first-type current controllers. Each first-type current controller includes an adjustable current source and a current detection and control unit, and its I-V curve may also be shown in FIG. 2. In the first-type current controller represented by CCA₁˜CCA_{N}, the current detection and control units UNA₁˜UNA_{N}, respectively coupled in series to the corresponding luminescent devices A₁˜A_{N} and the corresponding adjustable current sources ISA₁˜ISA_{N}, are configured to regulate the values of the adjustable current sources ISA₁˜ISA_{N} according the current I_{AK1}˜I_{AKN}, respectively. In the first-type current controller represented by CCA₁′˜CCA_{N}′, the current detection and control units UNA₁′˜UNA_{N}′, respectively coupled in series to the corresponding luminescent devices B₁˜B_{N} and the corresponding adjustable current sources ISA₁′˜ISA_{N}′, are configured to regulate the values of the adjustable current sources ISA₁′˜ISA_{N}′ according the current I_{BK1}˜I_{BKN}, respectively. The overall operation of the LED lighting device 200 may also be shown in FIG. 7.

With the above-mentioned multi-stage driving scheme, all luminance devices may be simultaneously light up and the overall current may be flexibly regulated by corresponding current controllers. Therefore, the LED lighting device of the present invention may improve the effective operational voltage range without causing image flicker and uniformity issue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light-emitting diode (LED) lighting device having multiple driving stages, comprising:
a first driving stage including:
a first luminescent device for providing light according to a first current;
a second luminescent device for providing light according to a second current;
a first current controller coupled in series to the first luminescent device and configured to regulate the first current so that the first current does not exceed a first value;
a second current controller coupled in series to the second luminescent device and configured to regulate the second current so that the second current does not exceed a second value;
a first path-controller configured to conduct a third current and comprising:
a first end coupled between the second luminescent device and the second current controller; and
a second end coupled to the first current controller; and
a second driving stage including:
a third current controller coupled in series to the first driving stage and configured to conduct a fourth current and regulate the fourth current so that the fourth current does not exceed a third value.

2. The LED lighting device of claim 1, wherein:
during a rising period or a falling period of a rectified alternative-current (AC) voltage when the voltage established across the first current controller does not exceed a first voltage, the first current controller operates in a first mode in which the first current changes with the voltage established across the first current controller;
during the rising period or the falling period when the third current does not exceed the first value, the first current controller operates in a second mode in which the first current is maintained at the first value; and
during the rising period or the falling period when the third current exceeds the first value, the first current controller operates in a third mode in which the first current controller is turned off.

3. The LED lighting device of claim 1, wherein:
during a rising period or a falling period of a rectified AC voltage when a voltage established across the second current controller does not exceed a third voltage, the second current controller operates in a first mode in which the second current changes with the voltage established across the second current controller;
during the rising period when the voltage established across the second current controller exceeds the third voltage but does not exceed a fourth voltage, the second current controller operates in a second mode in which the second current is maintained at the second value; and
during the rising period when the voltage established across the second current controller exceeds the fourth voltage, the second current controller operates in a third mode in which the second current controller is turned off.

4. The LED lighting device of claim 3, wherein:
during the falling period when the voltage established across the second current controller exceeds the third voltage but does not exceed a fifth voltage, the second current controller operates in the second mode in which the second current is maintained at the second value, and the fifth voltage is larger than or equal to the fourth voltage.

5. The LED lighting device of claim 1, wherein:
during a rising period or a falling period of a rectified AC voltage when the voltage established across the third current controller does not exceed a sixth voltage, the third current controller operates in a first mode in which the fourth current changes with the voltage established across the second current controller; and
during the rising period or the falling period when the voltage established across the third current controller exceeds the sixth voltage, the third current controller operates in a second mode in which the fourth current is maintained at the third value.

6. The LED lighting device of claim 1, wherein the first current controller includes:
a first adjustable current source configured to conduct a fifth current; and
a first detection and control unit configured adjust the fifth current according to the first current or the third current, and comprising:
a first end coupled to the second end of the first path-controller and the first adjustable current source; and
a second end coupled to the first luminescent device.

7. The LED lighting device of claim 1, wherein the second current controller includes:
a second adjustable current source configured to conduct a sixth current; and
a second detection and control unit coupled in parallel with the second adjustable current and configured adjust the sixth current according to a voltage established across the second current controller.

8. The LED lighting device of claim 1, wherein:
the first current controller includes:
a first adjustable current source configured to conduct a fifth current; and
a first detection and control unit configured adjust the fifth current according to the first current or the third current, and comprising:
a first end coupled to the second end of the first path-controller and the first adjustable current source; and
a second end coupled to the first luminescent device; and
the second current controller includes:
a second adjustable current source configured to conduct a sixth current; and
a second detection and control unit coupled in series to the second adjustable current and configured adjust the sixth current according to the second current or the third current.

9. The LED lighting device of claim 1, wherein the third current controller includes:
a third adjustable current source configured to conduct the fourth current; and
a third detection and control unit coupled in series to the third adjustable current source and configured to control the third adjustable current source according to the fourth current.

10. The LED lighting device of claim 1, further comprising a third driving stage coupled between the first driving stage and the second driving stage, and includes:
a third luminescent device for providing light according to a seventh current;
a fourth luminescent device for providing light according to an eighth current;
a fourth current controller coupled in series to the third luminescent device and configured to regulate the seventh current so that the seventh current does not exceed a fourth value;
a fifth current controller coupled in series to the fourth luminescent device and configured to regulate the eighth current so that the eighth current does not exceed a fifth value; and
a second path-controller configured to conduct a ninth current and comprising:
a first end coupled between the fourth luminescent and the fifth current controller; and
a second end coupled to the fourth current controller.

11. The LED lighting device of claim 1, further comprising a power supply circuit configured to provide a rectified AC voltage for driving the first luminescent device and the second luminescent device.

12. The LED lighting device of claim 11, wherein the power supply circuit includes an AC-AC voltage converter.

13. The LED lighting device of claim 1, wherein the first path-controller includes a diode.

14. The LED lighting device of claim 1, wherein:
the first luminescent is coupled in parallel with the second luminescent when the first path-controller is turned off; and
the first luminescent is coupled in series to the second luminescent when the first path-controller is turned on.

15. The LED lighting device of claim 1, wherein:
when the first path-controller is turned off, the third current is zero, and the fourth current is equal to a sum of the first current and the second current; and
when the first path-controller is turned on, the first current, the second current, the third current and the fourth current is equal.
